(19) United States
(12) Patent Application Publication
(10) Pub. No.: US 2026/0042035 A1
(43) Pub. Date: Feb. 12, 2026

(54) Methods of Solvent Extraction Having Reduced Crud or Improved Phase Disengagement Times

(71) Applicant: Kemira OYJ, Helsinki (FI)

(72) Inventors: Luiz G. Greca, Espoo (FI); Petrus Pretorius, Bradlec (CZ); Mehrdad Hesampour, Espoo (FI); Orlando Rojas, Espoo (FI)

(21) Appl. No.: 19/100,321

(22) PCT Filed: Jul. 18, 2023
(86) PCT No.: PCT/US2023/028055

§ 371 Date: Jan. 31, 2025

Related U.S. Application Data
(60) Provisional application No. 63/394,491, filed on Aug. 2, 2022.

(51) Int. Cl. B01D 11/04

(52) U.S. Cl. CPC B01D 11/0492

(57) ABSTRACT

Methods of solvent extraction are provided, including methods that exhibit improved phase disengagement times or reduced crud. The methods may include contacting an aqueous phase with a phase disengagement agent. The phase disengagement agent may improve a phase disengagement time. The methods may include contacting an aqueous phase with a crud reducing agent.

### CROSS-REFERENCE TO RELATED APPLICATIONS

This application claims priority to and the benefit of U.S. Provisional Application No. 63/394,491, filed Aug. 2, 2022, which is hereby incorporated by reference herein in its entirety.

### FIELD OF THE DISCLOSURE

This disclosure relates to methods of solvent extraction, including methods having improved phase disengagement times, or reduced crud.

### BACKGROUND

Solvent extraction, which may be referred to as liquid-liquid extraction or partitioning, may be used to separate a compound based on solubility, such as the solubilities of the compounds' parts. Typically, solvent extraction relies on two liquids with no, or limited, solubility in each other, such as water and an organic liquid.

Solvent extraction processes usually include extraction and a stripping reaction. In an extraction stage, a solvent and an aqueous phase are separated in a settler. The phase continuity and/or the time of phase separation, which may be referred to as the phase disengagement time, can be operating parameters that inform the efficiency of extraction processes, such as copper extraction processes. As a result, reducing disengagement time and/or improving phase separation could have a number of advantages, such as reducing environmental impact through improved phase separation, reducing operating costs caused by extractant losses while reducing maintenance, and/or improving revenue.

Solvent extraction plants typically suffer from an accumulation of solids, which is commonly referred to as “crud”. The crud may be composed mainly of silica. The presence of crud can influence a number of parameters, such as the continuity of organic-aqueous phases, emulsion stability, and, therefore, phase disengagement time. The presence of crud also can increase the cost of operation, possibly due to the loss of organic phases.

The removal of crud from a settler or other part of a solvent extraction process or apparatus can be difficult and/or laborious, and can require the shutdown of a plant, which can further increase losses.

There remains a need for improved methods of solvent extraction, including methods that enjoy reduced phase disengagement times, and methods that eliminate or reduce crud.

### BRIEF SUMMARY

Provided herein are methods of solvent extraction that can reduce or eliminate crud, such as by preventing or reducing further polymerization and/or aggregation of silica by removing excess silica from an aqueous phase, preferably before contacting an aqueous phase and an organic phase. Also provided herein are methods of solvent extraction with reduced phase disengagement times.

By reducing phase disengagement times and/or reducing or eliminating crud formation, embodiments of the methods provided herein can reduce the environmental impact of solvent extraction, reduce operating costs, and/or free up plant capacity.

In one aspect, methods of solvent extraction having reduced phase disengagement times are provided. In some embodiments, the methods include providing an aqueous phase; contacting the aqueous phase and an organic phase; contacting the aqueous phase and a phase disengagement agent (i) before the contacting of the aqueous phase and the organic phase, or (ii) after the contacting of the aqueous phase and the organic phase; and separating the aqueous phase and the organic phase. The separating of the aqueous phase and the organic phase may be completed at a phase disengagement time that at least 2%, at least 3%, at least 4%, at least 5%, at least 10%, at least 15%, at least 20%, at least 25%, at least 30%, at least 35%, at least 40%, at least 45%, at least 50%, at least 60%, at least 70%, at least 80%, at least 90%, about 2% to about 90%, about 2% to about 80%, about 2% to about 70%, about 2% to about 60%, about 2% to about 50%, about 2% to about 45%, about 2% to about 40%, about 2% to about 35%, about 2% to about 30%, about 2% to about 25%, about 2% to about 20%, about 2% to about 15%, about 2% to about 10%, about 2% to about 5%, about 2% to about 4%, about 5% to about 10%, about 40% to about 90%, or about 40% to about 80% less than a time to separate the aqueous phase and the organic phase in the absence of the phase disengagement agent.

In another aspect, methods of solvent extraction that include crud reduction or elimination are provided. In some embodiments, the methods include providing an aqueous phase; contacting the aqueous phase and a crud reducing agent; and removing at least a portion of the first amount of silica from the aqueous phase to form a treated aqueous phase comprising a second amount of silica. The second amount of silica may be at least 2%, at least 5%, at least %, at least 15%, at least 20%, at least 25%, or at least 50% less than the first amount of silica. The methods also may include contacting the treated aqueous phase and an organic phase; and separating the treated aqueous phase and the organic phase.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 depicts a plot of phase disengagement times observed for embodiments of aqueous phases including various concentrations of an embodiment of a non-ionic surface active agent.

FIG. 2 depicts a plot of phase disengagement times observed for embodiments of aqueous phases including various concentrations of an embodiment of a non-ionic surface active agent.

FIG. 3 depicts the performance of an embodiment of a non-ionic surface active agent at two different concentrations.

FIG. 4 depicts phase disengagement times observed for one embodiment of a non-ionic surface active agent at various concentrations in an embodiment of an aqueous phase.

FIG. 5 depicts phase disengagement times observed for one embodiment of a surface active agent at various concentrations in an embodiment of an aqueous phase.

FIG. 6 depicts phase disengagement times observed for one embodiment of a surface active agent.

FIG. 7 depicts a plot of particle size of an aqueous phase containing an embodiment of a surface active agent.

FIG. 8 depicts a plot of colloidal silica particle size versus colloidal silica concentration.

FIG. 9 depicts a calibration curve derived to assist a series of tests described herein.

FIG. 10 depicts a plot of phase disengagement times observed for a series of tests.

FIG. 11 depicts a plot of phase disengagement times after centrifugation of embodiments of aqueous phases.

FIG. 12 depicts a plot of copper extraction efficiency versus various concentrations of an embodiment of a surface active agent.

FIG. 13 depicts a plot of copper extraction efficiency versus various concentrations of two embodiments of a surface active agent.

FIG. 14 depicts a plot of copper extraction efficiency versus silica concentration.

FIG. 15 depicts copper extraction efficiencies for several embodiments of surface active agents.

FIG. 16 depicts a plot of phase engagement time versus concentration of an embodiment of a surface active agent.

FIG. 17 depicts a plot of phase engagement time versus concentration of an embodiment of a surface active agent.

FIG. 18 depicts an ultraviolet-visible spectroscopy (UV-Vis) analysis of an embodiment of an aqueous phase.

FIG. 19 depicts an embodiment of a calibration curve used in certain tests described herein.

### DETAILED DESCRIPTION

Provided herein are methods of solvent extraction. In some embodiments, the methods exhibit improved phase disengagement times. In some embodiments, the methods reduce or eliminate crud.

In some embodiments, the methods include providing an aqueous phase, contacting the aqueous phase and an organic phase, and separating the aqueous phase and the organic phase. The contacting of the aqueous phase and the organic phase, and the separating of the aqueous phase and the organic phase may be achieved by any known technique, including solvent extraction techniques known in the art.

### Improved Phase Disengagement Times

In some embodiments, the methods include contacting an aqueous phase and a phase disengagement agent (i) before the contacting of the aqueous phase and an organic phase, or (ii) after the contacting of the aqueous phase and an organic phase. For example, an aqueous phase may be contacted with all or a portion of an amount of a phase disengagement agent before and/or after the contacting of the aqueous phase and an organic phase (e.g., an aqueous phase may be contacted with (i) a first portion of a phase disengagement agent before the contacting of the aqueous phase and an organic phase, and (ii) a second portion of a phase disengagement agent after the contacting of the aqueous phase and an organic phase).

In some embodiments, the contacting of an aqueous phase and an organic phase includes mixing the aqueous phase and organic phase. Any mixing apparatus may be used to mix the aqueous phase and the organic phase. The mixing may occur for a mixing time, which may be a predetermined mixing time, and the contacting of the aqueous phase and the phase disengagement agent may occur before the mixing time commences, or after at least 25%, at least 50%, at least 60%, at least 70%, at least 80%, or at least 90%, or after 100% of the mixing time has transpired. For example, an aqueous phase and an organic phase may be subjected to mixing for a predetermined mixing time of one minute, and the aqueous phase and the phase disengagement agent are contacted 30 seconds after the onset of mixing.

In some embodiments, the methods include subjecting an aqueous phase to leaching prior to the contacting of the aqueous phase and an organic phase, and the aqueous phase and the phase disengagement agent are (i) contacted after the leaching, or (ii) contacted after the leaching and before the contacting of the aqueous phase and the organic phase. As used herein, the term “leaching” refers to and includes (i) a process or portion of a process that includes extracting a substance from a medium by dissolving the substance with a solvent or lixiviant, and (ii) bioleaching (e.g., microbial leaching), which generally includes extracting a material, such as a metal from an ore, with an organism.

In some embodiments, the separating of the aqueous phase and the organic phase is completed (i.e., complete phase separation (with no bubbles visible), see Example 2) at a phase disengagement time that is at least 2%, at least 3%, at least 4%, at least 5%, at least 10%, at least 15%, at least 20%, at least 25%, at least 30%, at least 35%, at least 40%, at least 45%, at least 50%, at least 60%, at least 70%, at least 80%, at least 90%, about 2% to about 90%, about 2% to about 80%, about 2% to about 70%, about 2% to about 60%, about 2% to about 50%, about 2% to about 45%, about 2% to about 40%, about 2% to about 35%, about 2% to about 30%, about 2% to about 25%, about 2% to about 20%, about 2% to about 15%, about 2% to about 10%, about 2% to about 5%, about 2% to about 4%, about 5% to about 10%, about 40% to about 90%, or about 40% to about 80% less than a time to separate the aqueous phase and the organic phase (i.e., achieve the same complete phase separation) in the absence of the phase disengagement agent. For example, if the time to separate an aqueous phase and an organic phase in the absence of a phase disengagement agent is 100 seconds, then the contacting of the aqueous phase with a phase disengagement agent may reduce the time to separate the aqueous phase and the organic phase (i.e., the phase disengagement time) to 75 seconds or less (a reduction of at least 25%), 70 seconds or less (a reduction of at least 30%), etc.

An aqueous phase may be contacted with any effective amount of a phase disengagement agent. In some embodiments, a phase disengagement agent is present at an amount, relative to the aqueous phase, of about 5 ppm to about 1,000 ppm, 100 ppm to about 1,000 ppm, about 100 ppm to about 700 ppm, about 100 ppm to about 600 ppm, about 200 ppm to about 600 ppm, about 300 ppm to about 600 ppm, about 100 ppm to about 500 ppm, about 100 ppm to about 400 ppm, or about 100 ppm to about 300 ppm.

### Crud Reduction

In some embodiments, the methods provided herein include providing an aqueous phase, contacting the aqueous phase and a crud reducing agent; and removing at least a portion of the first amount of silica from the aqueous phase to form a treated aqueous phase that includes a second amount of silica. The methods also may include contacting the treated aqueous phase and an organic phase, and separating the treated aqueous phase and the organic phase. The contacting of a treated aqueous phase and an organic phase, as described herein, may include mixing the aqueous phase and the organic phase.

The crud reducing agent may ease and/or facilitate the elimination or reduction of crud in the aqueous phase. For example, a crud reducing agent may increase the average particle size of silica-containing aggregates, thereby permitting sedimentation, increasing the rate of sedimentation, or a combination thereof. For example, the first amount of silica may be present in the aqueous phase in the form of particles having a first average particle size, as measured by dynamic light scattering, and after the contacting of the aqueous phase and the crud reducing agent (e.g., at least 5 seconds, at least 10 seconds, or at least 20 seconds after the contacting of the aqueous phase and the crud reducing agent), the first amount of silica may be present in the aqueous phase in the form of particles having a second average particle size, as measured by dynamic light scattering, and the second average particle size may be at least 2 times, at least 3 times, at least 4 times, at least 5 times, or at least 10 times greater than the first average particle size.

The removing of at least a portion of the first amount of silica from the aqueous phase to form a treated aqueous phase that includes a second amount of silica may be achieved by any known technique, including conventional solid-liquid separation techniques. The technique may be an active technique, a passive technique, or a combination thereof. A “passive technique” relies on gravity to achieve sedimentation, whereas an “active technique” relies on at least one force other than gravity. For example, the removing of at least a portion of the first amount of silica may include centrifuging the aqueous phase, which is an “active technique”. The sedimentation, as described herein, may occur and/or have an increased rate due, at least in part, to an increased particle size of silica-containing aggregates. After sedimentation has reached a desired level, the silica, e.g., silica-containing aggregates, may be removed by any known technique, such as decanting.

In some embodiments, the first amount of silica in the aqueous phase is about 0.5 g/L to about 3 g/L, about 0.5 g/L to about 2 g/L, or about 0.5 g/L to about 1.5 g/L. In some embodiments, the second amount of silica is at least 2%, at least 5%, at least 10%, at least 15%, at least 20%, at least 25%, at least 30%, at least 35%, at least 40%, at least 45%, at least 50%, at least 60%, at least 70%, at least 80%, at least 85%, at least 90%, at least 95%, or at least 99% less than the first amount of silica. For example, if the first amount of silica in the aqueous phase is 2 g/L and the second amount of silica is at least 99% less than the first amount of silica, then the second amount of silica is 0 g/L to about 0.02 g/L.

An aqueous phase generally may be contacted with any effective amount of a crud reducing agent. For example, an effective amount may include a concentration less than or equivalent to the critical micelle concentration (CMC) of a crud reducing agent. In some embodiments, after the contacting of the aqueous phase and the crud reducing agent, the crud reducing agent is present in the aqueous phase at an amount of about 0.1 ppm to about 200 ppm, about 0.1 ppm to about 180 ppm, about 0.1 ppm to about 160 ppm, about 0.1 ppm to about 140 ppm, about 0.1 ppm to about 120 ppm, about 0.1 ppm to about 100 ppm, about 0.1 ppm to about 80 ppm, about 0.1 ppm to about 60 ppm, about 0.1 ppm to about 40 ppm, about 0.1 ppm to about 20 ppm, about 0.1 ppm to about 12 ppm, about 1 ppm to about 10 ppm, about 2 ppm to about 10 ppm, about 3 ppm to about 10 ppm, about 4 ppm to about 10 ppm, about 5 ppm to about 10 ppm, about 6 ppm to about 10 ppm, about 7 ppm to about 10 ppm, about 8 ppm to about 10 ppm, about 9 ppm to about 10 ppm, about 2 ppm to about 8 ppm, about 3 ppm to about 7 ppm, or about 4 ppm to about 6 ppm.

When performed, the centrifuging of an aqueous phase may include subjecting the aqueous phase to an effective gravitational force equivalent (g-force), such as up to 20,000, up to 15,000, or up to 10,000. In some embodiments, the centrifuging of an aqueous phase includes subjecting the aqueous phase to a g-force of about 10 to about 8,000, about 100 to about 8,000, about 1,000 to about 8,000, about 2,000 to about 5,000, or about 3,000 to about 4,500.

The centrifuging of the aqueous phase may occur for an effective period, which may depend on one or more factors, such as incoming volume, type of centrifuge, operating parameters of the centrifuge, etc. The centrifuging of the aqueous phase may occur for a period of about 10 seconds to about 500 seconds, about 10 seconds to about 400 seconds, about 10 seconds to about 300 seconds, about 10 seconds to about 200 seconds, 10 about 10 seconds to about 120 seconds, about 20 seconds to about 100 seconds, or about 30 seconds to about 60 seconds.

### Phase Disengagement Agents and Crud Reducing Agents

The phase disengagement agents and crud reducing agents may include any compound that is effective to achieve the limitations described herein. In some embodiments, the phase disengagement agent or the crud reducing agent includes a surface active agent (e.g., a surfactant). The surface active agent may include an anionic surface active agent, a non-ionic surface active agent, a cationic surface active agent, or a combination thereof. In some embodiments, the phase disengagement agent or the crud reducing agent comprises one or more non-ionic surface active agents. In some embodiments, the phase disengagement agent or the crud reducing agent consists of or consists essentially of one or more non-ionic surface active agents, where “consisting essentially of” means no other surface active agents are present that affect phase disengagement time or silica removal. In some embodiments, the phase disengagement agent and the crud reducing agent are the same, and in some embodiments the phase disengagement agent and the crud reducing agent are different.

In some embodiments, the surface active agent has a hydrophilic-lipophilic balance (HLB) that is equal to or greater than 10. In some embodiments, the surface active agent has a HLB of about 10 to about 18, about 12 to about 18, about 12 to about 17, about 13 to about 16, or about 14.5 to about 15.5. In some embodiments, the surface active agent has a weight average molecular weight (M_{w}) of about 0.2 kDa to about 100 kDa, about 0.5 kDa to about 100 kDa, about 0.2 kDa to about 80 kDa, about 0.2 kDa to about 60 kDa, about 0.2 kDa to about 40 kDa, about 0.2 kDa to about 20 kDa, about 0.2 kDa to about 10 kDa, about 0.2 kDa to about 5 kDa, about 0.2 kDa to about 2 kDa, about 1 kDa to about 2 kDa, about 1 kDa to about 1.5 kDa, or about 1.2 kDa to about 1.4 kDa.

In some embodiments, the surface active agent includes a polysorbate, a polyoxyethylene sorbitan monooleate, a polyethylene glycol sorbitan monolaurate, a polyethylene glycol polypropylene glycol block copolymer, or a combination thereof.

In some embodiments, the non-ionic surface active agent has a structure according to the following formula:

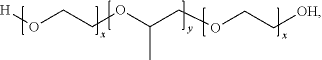

wherein x is 2 to 150, and y is 5 to 100. In some embodiments, x is 70 to 90 and y is 20 to 40; x is 125 to 145 and y is 40 to 60; x is 85 to 105 and y is 50 to 70; x is 5 to 15 and y is 15 to 25; x is 10 to 20 and y is 20 to 40; x is 20 to 30 and y is 35 to 45; x is 30 to 40 and y is 45 to 55; x is 2 to 5 and y is 25 to 35; x is 15 to 25 and y is 50 to 70; x is 2 to 10 and y is 50 to 70; or wherein x and y are selected from the following table:

| Embodiment | x | y |
|---|---|---|
| A | 82 | 31 |
| B | 136 | 52 |
| C | 95 | 62 |
| D | 10 | 16 |
| E | 9 | 21 |
| F | 14 | 31 |
| G | 27 | 41 |
| H | 34 | 52 |
| I | 2 | 31 |
| J | 18 | 62 |
| K | 5 | 62 |

In some embodiments, (i) the phase disengagement agent and/or the crud reducing agent does not include a thiocarbonyl functional group, (ii) the aqueous phase does not include a compound comprising a thiocarbonyl functional group, or (iii) the phase disengagement agent and/or the crud reducing agent does not include a thiocarbonyl functional group, and the aqueous phase does not include a compound comprising a thiocarbonyl functional group.

### Aqueous Phase

In some embodiments, the aqueous phases provided herein include water. In some embodiments, the aqueous phases provided herein include water and a material to be extracted.

In some embodiments, the aqueous phases provided herein include water, a material to be extracted, and silica. The aqueous phase may include one or more suspended solids; therefore, in some instances, the aqueous phase may be referred to as a “slurry”. As a result, limitations such as “providing an aqueous phase” and “contacting the aqueous phase and a crud reducing agent” read on providing a slurry and contacting the slurry and a crud reducing agent. An aqueous phase also may include an acid, such as sulfuric acid.

The water of the aqueous phases provided herein may include deionized water. The water may be present in the aqueous phases at any effective amount. Typically, water is present in an aqueous phase at a concentration and/or amount that is greater than the concentration and/or amount of each of the other components that may be present in the aqueous phase. In some embodiments, the water is present in an aqueous phase at an amount of about 40% to about 99.999%, about 50% to about 99.999%, about 60% to about 99.999%, about 75% to about 99.999%, about 80% to about 99.999%, about 85% to about 99.999%, about 90% to about 99.999%, about 95% to about 99.999%, about 98% to about 99.999%, or about 99% to about 99.999%, by weight.

Silica may be present at any amount. In some embodiments, silica is present in the aqueous phase (e.g., prior to contacting an aqueous phase and a crud reducing agent) at an amount of about 0.5 g/L to about 3 g/L, about 0.5 g/L to about 2 g/L, or about 0.5 g/L to about 1.5 g/L. The silica may present, at least initially (e.g., prior to contact an aqueous phase and a crud reducing agent), in the aqueous phase in the form of particles having a first average particle size, as measured by dynamic light scattering.

An aqueous phase may have an acidic pH. In some embodiments, the aqueous phase has a pH that is less than or equal to 3, less than or equal to 2.5, or about 2. During and/or after the preparation of an aqueous phase, a pH of an aqueous phase may be modified, such as by reducing the pH.

The “material to be extracted” may include an element and/or compound that is extractable with the methods provided herein. In some embodiments, the material to be extracted includes one or more metals. The one or more metals may include one or more rare earth metals, one or more precious metals, or a combination thereof. The one or more metals may include copper, iron, uranium, nickel, cobalt, vanadium, molybdenum, germanium, palladium, or a combination thereof. In some embodiments, the metal is copper. The one or more metals may be present in the form of one or more metal-containing compounds, such as one or more metal oxides, one or more metal sulfides, one or more metal salts, such as CuSO₄, FeSO₄, or a combination thereof. Each material to be extracted, such as each of the one or more metals (for example, copper), may be present in the aqueous phase (before the aqueous phase and an organic phase are contacted) at an amount of about 1 g/L to about 20 g/L, about 1 g/L to about 15 g/L, about 1 g/L to about 10 g/L, about 2 g/L to about 8 g/L, or about 3 g/L to about 6 g/L.

### Organic Phase

In some embodiments, the organic phases provided herein include an organic liquid. In some embodiments, the organic phases provided herein include an organic liquid and an extraction reagent. Typically, an organic liquid is present in an organic phase at a concentration and/or amount that is greater than the concentration and/or amount of each of the other components that may be present in the organic phase.

As used herein, the phrase “organic liquid” refers to a compound that (i) is in the liquid phase at 20° C. and 1 atmosphere, (ii) has no or limited (i.e., ≤10 mg/L) solubility in water, and (iii) has a chemical formula featuring carbon and hydrogen, wherein carbon and hydrogen, in total, constitute at least 70%, at least 80%, at least 90%, at least 95%, or 100% of the molecular weight of the compound. Non-limiting examples of organic liquids include alkanes, alkenes, and alkynes, each of which may be linear, branched, cyclic (e.g., aromatic), or a combination thereof. In some embodiments, the organic liquid includes an oil, such as kerosene, diesel, or other fuel oil.

In some embodiments, the organic liquid is present in the organic phase at an amount of about 75% to about 100%, about 75% to about 98%, about 80% to about 95%, or about 85% to about 95%, by volume.

Generally, any extraction reagent known in the art may be included in an organic phase, including those that are commercially available. In some embodiments, the extraction reagent includes an aromatic moiety. In some embodiments, the extraction reagent includes an aromatic substituted oxime. An extraction reagent may be present at any effective amount. In some embodiments, the extraction reagent is present in the organic phase at an amount of about 2% to about 30%, about 2% to about 25%, about 2% to about 20%, about 5% to about 20%, or about 5% to about 15%, by volume.

### EMBODIMENTS

The following is a non-limiting list of embodiments.

Embodiment 1. A method of solvent extraction, the method comprising:
(A) providing an aqueous phase; contacting the aqueous phase and an organic phase; contacting the aqueous phase and a phase disengagement agent (i) before the contacting of the aqueous phase and the organic phase, or (ii) after the contacting of the aqueous phase and the organic phase; and separating the aqueous phase and the organic phase; or
(B) providing an aqueous phase comprising water and a material to be extracted; contacting the aqueous phase and an organic phase, wherein the organic phase comprises an organic liquid and optionally an extraction reagent; contacting the aqueous phase and a phase disengagement agent (i) before the contacting of the aqueous phase and the organic phase, or (ii) after the contacting of the aqueous phase and the organic phase; and separating the aqueous phase and the organic phase; or
(C) providing an aqueous phase comprising water, a material to be extracted, and silica; contacting the aqueous phase and an organic phase, wherein the organic phase comprises an organic liquid and optionally an extraction reagent; contacting the aqueous phase and a phase disengagement agent (i) before the contacting of the aqueous phase and the organic phase, or (ii) after the contacting of the aqueous phase and the organic phase; and separating the aqueous phase and the organic phase; or
(D) providing an aqueous phase comprising water, a material to be extracted, and a first amount of silica; contacting the aqueous phase and a crud reducing agent; removing at least a portion of the first amount of silica from the aqueous phase to form a treated aqueous phase comprising a second amount of silica, wherein the removing of at least a portion of the first amount of silica from the aqueous phase comprises an active technique, such as centrifugation, a passive technique, or a combination thereof; contacting the treated aqueous phase and an organic phase, wherein the organic phase comprises an organic liquid and optionally an extraction reagent; contacting the treated aqueous phase and a phase disengagement agent (i) before the contacting of the treated aqueous phase and the organic phase, or (ii) after the contacting of the treated aqueous phase and the organic phase; and separating the treated aqueous phase and the organic phase.

Embodiment 2. The method of Embodiment 1, wherein the separating of the aqueous phase (or treated aqueous phase) and the organic phase is completed at a phase disengagement time that is at least 2%, at least 3%, at least 4%, at least 5%, at least 10%, at least 15%, at least 20%, at least 25%, at least 30%, at least 35%, at least 40%, at least 45%, at least 50%, at least 60%, at least 70%, at least 80%, at least 90%, about 2% to about 90%, about 2% to about 80%, about 2% to about 70%, about 2% to about 60%, about 2% to about 50%, about 2% to about 45%, about 2% to about 40%, about 2% to about 35%, about 2% to about 30%, about 2% to about 25%, about 2% to about 20%, about 2% to about 15%, about 2% to about 10%, about 2% to about 5%, about 2% to about 4%, about 5% to about 10%, about 40% to about 90%, or about 40% to about 80% less than a time to separate the aqueous phase (or treated aqueous phase) and the organic phase in the absence of the phase disengagement agent.

Embodiment 3. The method of any of the preceding embodiments, wherein the contacting of the aqueous phase (or treated aqueous phase) and the organic phase comprises mixing the aqueous phase (or treated aqueous phase) and organic phase.

Embodiment 4. The method of Embodiment 3, wherein the mixing occurs for a mixing time, which may be a predetermined mixing time, and the contacting of the aqueous phase (or treated aqueous phase) and the phase disengagement agent occurs before the mixing time commences, or after at least 25%, at least 50%, at least 60%, at least 70%, at least 80%, or at least 90%, or after 100% of the mixing time has transpired.

Embodiment 5. The method of any of Embodiments 1 to 3, further comprising subjecting the aqueous phase (or treated aqueous phase) to leaching prior to the contacting of the aqueous phase (or treated aqueous phase) and the organic phase, wherein the aqueous phase (or treated aqueous phase) and the phase disengagement agent are contacted after the leaching and before the contacting of the aqueous phase (or treated aqueous phase) and the organic phase.

Embodiment 6. The method of any of the preceding embodiments, wherein the phase disengagement agent comprises, consists of, or consists essentially of a surface active agent.

Embodiment 7. The method of any of the preceding embodiments, wherein (i) the phase disengagement agent does not include a thiocarbonyl functional group, (ii) the aqueous phase does not include a compound comprising a thiocarbonyl functional group, or (iii) the phase disengagement agent does not include a thiocarbonyl functional group, and the aqueous phase does not include a compound comprising a thiocarbonyl functional group.

Embodiment 8. The method of any of the preceding embodiments, wherein the phase disengagement agent is present at an amount, relative to the aqueous phase (or treated aqueous phase), of about 5 ppm to about 1,000 ppm, 100 ppm to about 1,000 ppm, about 100 ppm to about 700 ppm, about 100 ppm to about 600 ppm, about 200 ppm to about 600 ppm, about 300 ppm to about 600 ppm, about 100 ppm to about 500 ppm, about 100 ppm to about 400 ppm, or about 100 ppm to about 300 ppm.

Embodiment 9. A method of solvent extraction, the method comprising providing an aqueous phase comprising water, a material to be extracted, and a first amount of silica; contacting the aqueous phase and a crud reducing agent; and removing at least a portion of the first amount of silica from the aqueous phase to form a treated aqueous phase comprising a second amount of silica, wherein the removing of at least a portion of the first amount of silica from the aqueous phase comprises an active technique, such as centrifugation, a passive technique, or a combination thereof.

Embodiment 10. The method of Embodiment 1 or 9, wherein the second amount of silica is at least 2%, at least 5%, at least 10%, at least 15%, at least 20%, at least 25%, at least 30%, at least 35%, at least 40%, at least 45%, at least 50%, at least 60%, at least 70%, at least 80%, at least 85%, at least 90%, at least 95%, or at least 99% less than the first amount of silica.

Embodiment 11. The method of Embodiment of 1, 9 or 10, further comprising contacting the treated aqueous phase and an organic phase, wherein the organic phase comprises an organic liquid and optionally an extraction reagent; and separating the treated aqueous phase and the organic phase.

Embodiment 12. The method of Embodiment 11, wherein the contacting of the treated aqueous phase and the organic phase comprises mixing the treated aqueous phase and organic phase.

Embodiment 13. The method of any one of Embodiments 1 or 9 to 12, wherein the removing of the at least a portion of the first amount of silica from the aqueous phase comprises centrifuging and decanting the aqueous phase.

Embodiment 14. The method of any one of Embodiments 1 or 9 to 13, wherein the crud reducing agent comprises, consists of, or consists essentially of a surface active agent.

Embodiment 15. The method of any one of Embodiments 1 or 9 to 14, wherein (i) the crud reducing agent does not include a thiocarbonyl functional group, (ii) the aqueous phase does not include a compound comprising a thiocarbonyl functional group, or (iii) the crud reducing agent does not include a thiocarbonyl functional group, and the aqueous phase does not include a compound comprising a thiocarbonyl functional group.

Embodiment 16. The method of any one of Embodiments 1 or 9 to 15, wherein after the contacting of the aqueous phase and the crud reducing agent, the crud reducing agent is present in the aqueous phase at an amount (i) that is less than or equivalent to the critical micelle concentration (CMC) of a crud reducing agent, or (ii) of about 0.1 ppm to about 200 ppm, about 0.1 ppm to about 180 ppm, about 0.1 ppm to about 160 ppm, about 0.1 ppm to about 140 ppm, about 0.1 ppm to about 120 ppm, about 0.1 ppm to about 100 ppm, about 0.1 ppm to about 80 ppm, about 0.1 ppm to about 60 ppm, about 0.1 ppm to about 40 ppm, about 0.1 ppm to about 20 ppm, about 0.1 ppm to about 12 ppm, about 1 ppm to about 10 ppm, about 2 ppm to about 10 ppm, about 3 ppm to about 10 ppm, about 4 ppm to about 10 ppm, about 5 ppm to about 10 ppm, about 6 ppm to about 10 ppm, about 7 ppm to about 10 ppm, about 8 ppm to about 10 ppm, about 9 ppm to about 10 ppm, about 2 ppm to about 8 ppm, about 3 ppm to about 7 ppm, or about 4 ppm to about 6 ppm.

Embodiment 17. The method of any one of Embodiments 1 or 9 to 16, wherein the centrifuging of the aqueous phase comprises subjecting the aqueous phase to a gravitational force equivalent (g-force) up to 20,000, up to 15,000, or up to 10,000; for example, about 10 to about 8,000, about 100 to about 8,000, about 1,000 to about 8,000, about 2,000 to about 5,000, or about 3,000 to about 4,500.

Embodiment 18. The method of any one of Embodiments 1 or 9 to 17, wherein the centrifuging of the aqueous phase occurs for an effective period, which may depend on one or more factors, such as incoming volume, type of centrifuge, operating parameters of the centrifuge, etc.

Embodiment 19. The method of any of the preceding embodiments, wherein the water is present in the aqueous phase (or treated aqueous phase) at a concentration and/or amount that is greater than the concentration and/or amount of each of the other components that may be present in the aqueous phase (or treated aqueous phase).

Embodiment 20. The method of any of the preceding embodiments, wherein the water is present in the aqueous phase at an amount of about 40% to about 99.999%, about 50% to about 99.999%, about 60% to about 99.999%, about 75% to about 99.999%, about 80% to about 99.999%, about 85% to about 99.999%, about 90% to about 99.999%, about 95% to about 99.999%, about 98% to about 99.999%, or about 99% to about 99.999%, by weight.

Embodiment 21. The method of any of the preceding embodiments, wherein the aqueous phase (or treated aqueous phase) has a pH that is less than or equal to 3, less than or equal to 2.5, or about 2.

Embodiment 22. The method of any of the preceding embodiments, wherein the material to be extracted comprises one or more metals.

Embodiment 23. The method of any of the preceding embodiments, wherein the one or more metals comprise (i) one or more rare earth metals, one or more precious metals, or a combination thereof; (ii) copper, iron, uranium, nickel, cobalt, vanadium, molybdenum, germanium, palladium, or a combination thereof; or (iii) copper.

Embodiment 24. The method of any of the preceding embodiments, wherein the one or more metals are present in the form of one or more metal-containing compounds, such as one or more metal oxides, one or more metal sulfides, one or more metal salts, such as CuSO₄, FeSO₄, or a combination thereof.

Embodiment 25. The method of any of the preceding embodiments, wherein each of the one or more metals is present in the aqueous phase (before the aqueous phase (or treated aqueous phase) and an organic phase are contacted) at an amount of about 1 g/L to about 20 g/L, about 1 g/L to about 15 g/L, about 1 g/L to about 10 g/L, about 2 g/L to about 8 g/L, or about 3 g/L to about 6 g/L.

Embodiment 26. The method of any of the preceding embodiments, wherein (i) the silica is present in the aqueous phase at an amount of about 0.5 g/L to about 3 g/L, about 0.5 g/L to about 2 g/L, or about 0.5 g/L to about 1.5 g/L, or (ii) the first amount of silica in the aqueous phase is about 0.5 g/L to about 3 g/L, about 0.5 g/L to about 2 g/L, about 0.5 g/L to about 1.5 g/L.

Embodiment 27. The method of any of the preceding embodiments, wherein (i) the silica is present in the aqueous phase in the form of particles, or (ii) the first amount of silica is present in the aqueous phase in the form of particles having a first average particle size, as measured by dynamic light scattering.

Embodiment 28. The method of any of the preceding embodiments, wherein, after the contacting of the aqueous phase and the crud reducing agent (e.g., at least 5 seconds, at least 10 seconds, or at least 20 seconds after the contacting of the aqueous phase and the crud reducing agent), the first amount of silica is present in the aqueous phase in the form of particles having a second average particle size, as measured by dynamic light scattering, wherein the second average particle size is at least 2 times, at least 3 times, at least 4 times, at least 5 times, or at least 10 times greater than the first average particle size of Embodiment 27.

Embodiment 29. The method of any of the preceding embodiments, wherein the surface active agent is a non-ionic surface active agent.

Embodiment 30. The method of Embodiment 29, wherein the non-ionic surface active agent comprises a polysorbate, a polyoxyethylene sorbitan monooleate, or a combination thereof.

Embodiment 31. The method of Embodiment 29, wherein the non-ionic surface active agent comprises polyethylene glycol sorbitan monolaurate.

Embodiment 32. The method of Embodiment 29, wherein the non-ionic surface active agent comprises a polyethylene glycol polypropylene glycol block copolymer.

Embodiment 33. The method of Embodiment 29, wherein the non-ionic surface active agent has a structure according to the following formula:

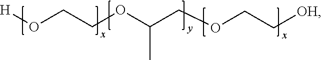

wherein x is 2 to 150, and y is 5 to 100.

Embodiment 34. The method of Embodiment 33, wherein x and y are selected from the following table:

| Embodiment | x | y |
|---|---|---|
| A | 82 | 31 |
| B | 136 | 52 |
| C | 95 | 62 |
| D | 10 | 16 |
| E | 9 | 21 |
| F | 14 | 31 |
| G | 27 | 41 |
| H | 34 | 52 |
| I | 2 | 31 |
| J | 18 | 62 |
| K | 5 | 62 |

Embodiment 35. The method of any one of Embodiments 29 to 34, wherein the non-ionic surface active agent has an HLB that is equal to or greater than 10; for example, about 10 to about 18, about 12 to about 18, about 12 to about 17, about 13 to about 16, or about 14.5 to about 15.5.

Embodiment 36. The method of any one of Embodiments 29 to 34, wherein the non-ionic surface active agent has a weight average molecular weight (M_{w}) of about 0.2 kDa to about 100 kDa, about 0.5 kDa to about 100 kDa, about 0.2 kDa to about 80 kDa, about 0.2 kDa to about 60 kDa, about 0.2 kDa to about 40 kDa, about 0.2 kDa to about 20 kDa, about 0.2 kDa to about 10 kDa, about 0.2 kDa to about 5 kDa, about 0.2 kDa to about 2 kDa, about 1 kDa to about 2 kDa, about 1 kDa to about 1.5 kDa, or about 1.2 kDa to about 1.4 kDa.

Embodiment 37. The method of any of the preceding embodiments, wherein the organic liquid is present in the organic phase at an amount of about 75% to about 100%, about 75% to about 98%, about 80% to about 95%, or about 85% to about 95%, by volume.

Embodiment 38. The method of any of the preceding embodiments, wherein the extraction reagent is present in the organic phase at an amount of about 2% to about 30%, about 2% to about 25%, about 2% to about 20%, about 5% to about 20%, or about 5% to about 15%, by volume.

Embodiment 39. The method of any of the preceding embodiments, wherein the organic liquid comprises an alkane, an alkene, an alkyne, or combination thereof, each of which may be linear, branched, cyclic, or a combination thereof.

Embodiment 40. The method of any of the preceding embodiments, wherein the organic liquid includes an oil, such as kerosene, diesel, or other fuel oil.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When methods are claimed or described in terms of “comprising” various steps or components, the methods can also “consist essentially of” or “consist of” the various steps or components, unless stated otherwise.

The terms “a,” “an,” and “the” are intended to include plural alternatives, e.g., at least one. For instance, the disclosure of “a surface active agent”, “an organic liquid”, and the like, is meant to encompass one, or mixtures or combinations of more than one surface active agent, organic liquid, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the extraction reagent is present in the organic phase at an amount of about 5% to about 15%, by volume. This range should be interpreted as encompassing about 5% and about 15%, and further encompasses “about” each of 6%, 7%, 8%, 9%, 10%, 11%, 12%, 13%, and 14%, including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Preparation of Aqueous and Organic Phases

The embodiments of the aqueous and organic phases used in the following examples were prepared as follows.

The organic phases were prepared using the following procedure. By considering the densities of kerosene (0.8 g mL⁻¹) and of the extraction reagent (0.95 g mL⁻¹), 288 g of kerosene and 38 g of extraction reagent were mixed to reach a final ratio of 10 v/v %.

TABLE 1
Embodiment of Organic Phase

| | Total | Desired | | | |
|---|---|---|---|---|---|
| | Volume | Concentration | Stock | Stock | Experiment |
| Component | (mL) | (Vol. %) | (mL) | (g) | (mL) |
| Kerosene | 400 | 90 | 360 | 288 | 8 |
| Extraction | | 10 | 40 | 38 | |
| Reagent | | | | | |

The extraction reagent may include a commercially-available extraction reagent. Although kerosene is present in the organic phase of this example, other organic liquids may be used, such as diesel oil, fuel oil, etc.

The aqueous phases used in this example and those that follow were prepared following the following procedure. A stock aqueous phase was prepared by diluting 9.52 g CuSO₄*5H₂O and 6.03 g FeSO₄*7H₂O in aqueous H₂SO₄ to a final volume of 400 mL and pH 2. These CuSO₄ and FeSO₄ quantities were calculated so that the final concentration of Cu and Fe ions in suspension would respectively be 6 and 3 g L⁻¹.

The pH after dissolving the salts was greater than 2, so the pH was adjusted to 2 by using 1M H₂SO₄. The final volume was reached by adding aqueous H₂SO₄ at pH 2.

TABLE 2
Embodiment of Aqueous Phase

| | Concen- | | | |
|---|---|---|---|---|
| | tration | Stock Preparation | | Experiment |
| Component | (g/L) | mL | g | (mL) |
| Deionized Water (pH 2) | — | 399.2 | — | 7.92 |
| Cu from CuSO₄ | 6 | — | 9.5 | |
| Fe from FeSO₄ | 3 | — | 6 | |
| Colloidal Silica (50 wt. %) | 1 | 0.8 | — | |
| Total | | 400 | | |

| | | |
|---|---|---|
| Surface active agent | See Table 4 | 0.08 |

The colloidal silica used in this example was a commercially available product, and had a diameter of about 44 nm, as measured by dynamic light scattering.

Stock surface active agent preparation: Concentrated stock solutions (e.g. 10 to 20 wt. %) of surface active agent were prepared to facilitate their addition in small quantities to the aqueous phase. At such small quantities, the increase in the aqueous volume was negligible (i.e. less than 0.25% increase) and not expected to affect the phase disengagement time in the following examples.

### Example 2—Preparation of Mixtures and Evaluation of Phase Disengagement

The aqueous and organic phases of Example 1 were mixed in this example. The mixing ratio of this example was as follows:

TABLE 3
Mixing Ratio of this Example

| Component | Mixing Ratio |
|---|---|
| Organic Phase | 1 |
| Aqueous Phase + Surface Active Agent | 1 |

The following steps were followed in this example: (1) the aqueous phase (8 mL) was added to a 20 mL glass vial, (2)(a) the silica (16 μL (50%), to reach a final concentration of 1,000 ppm in the aqueous phase) and the (2)(b) surface active agent were dispersed in the aqueous phase, (3) the organic phase (8 mL) was slowly added to the aqueous phase, (4) the aqueous and organic phases were mixed with an overhead mixer at 1700 rpm for 3 minutes, and (5) the time for full phase separation was measured. Instead of being implemented at step (2)(b), surface active agent addition was also tested immediately after step (4).

Between each test of this example, the impeller of the overhead stirred was washed with water, followed by acetone, and the glass vials were washed with water and soap, followed by acetone.

A number of surface active agents were tested, including the following non-ionic surface active agents: polyoxyethylene sorbitan monooleate; polyethylene glycol sorbitan monolaurate; and a polyethylene glycol polypropylene glycol block copolymer. Also tested were the following anionic surface active agents: sodium dodecyl sulfate, and lignosulfonate.

In this example, the following criteria were used to evaluate the phase disengagement time. The relevant literature reports that demulsification time may be evaluated based on the time needed for an arbitrary volume of one of the phases to separate from the emulsion. For example, it is often assumed as the time needed for half of the water phase to separate from the emulsion (see, e.g., Delgado-Linares, J. G. et al. (2016). Breaking of water-in-crude oil emulsions. 6. Estimating the demulsifier performance at optimum formulation from both the required dose and the attained instability. Energy & Fuels, 30 (7), 5483-5491). In this example, three different arbitrary phase disengagement conditions were used, each having advantages and disadvantages, but yielding similar results. The criteria were selected based on the literature: (i) the time needed to reach the impeller height (i.e., similar to Delgado-Linares, J. G. et al., ca. 50% total water volume), (ii) the time needed to reach the original interface height (some bubbles were expected to still be present), and (iii) the time needed to achieve complete phase separation (with no bubbles visible)(see, e.g., Seo, S. et al. (2021). Characterisation of Parameters Influencing the Phase Separation in Copper Solvent Extraction Systems Using Oxime-Type Extractants for the Field Operation. Metals, 11 (11), 1785).

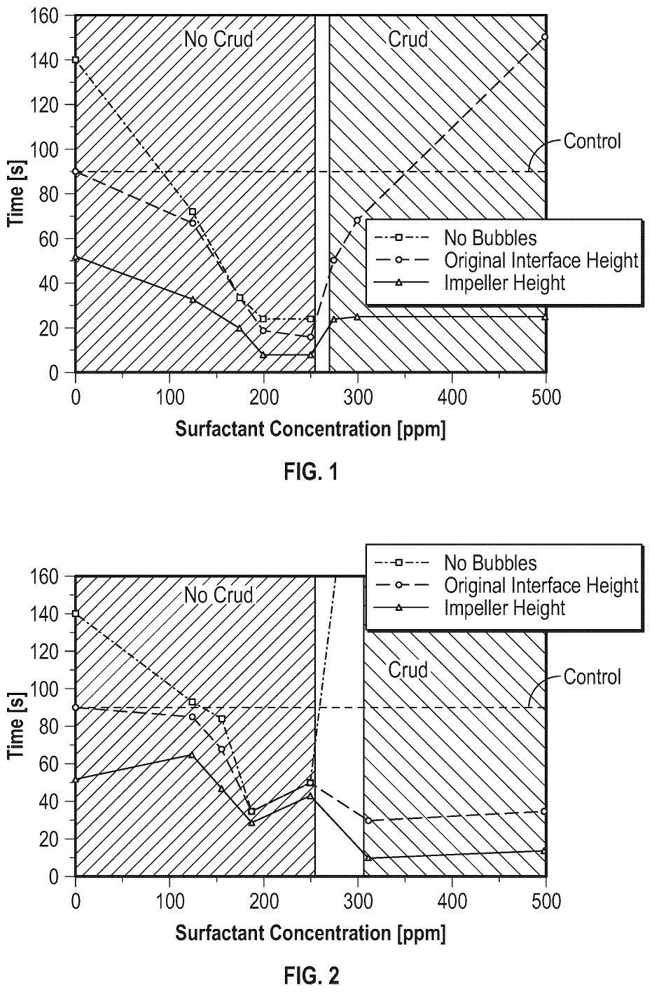

A control test was conducted in which no surface active agent was added to the aqueous phase. Tests were then conducted with aqueous phases containing polyoxyethylene sorbitan monooleate at concentrations of 125 ppm, 175 ppm, 200 ppm, 250 ppm, 275 ppm, 300 ppm, and 500 ppm. The results achieved at these concentrations of polyoxyethylene sorbitan monooleate are depicted at FIG. 1. The dashed line of FIG. 1 represents the control condition (i.e., the time needed for the 0 ppm surface active agent condition to reach the original interface height).

The plots of FIG. 1 depict the phase disengagement time versus polyoxyethylene sorbitan monooleate concentration, and demonstrate that when the concentration of polyoxyethylene sorbitan monooleate was less than about 300 ppm, the phase disengagement time was significantly lower than that of the control condition (i.e., 0 ppm polyoxyethylene sorbitan monooleate). At concentrations greater than about 270 ppm, the formation of a solids stabilized emulsion, known as crud, at the aqueous/organic interface was observed, and this layer prevented full phase separation. At concentrations of about 250 ppm or less, no crud was observed.

Tests also were conducted with aqueous phases containing polyethylene glycol sorbitan monolaurate at concentrations of 0 ppm (control), 125 ppm, 156 ppm, 187 ppm, 250 ppm, 312 ppm, and 498 ppm. The results achieved at these concentrations of polyethylene glycol sorbitan monolaurate are depicted at FIG. 2. The dashed line of FIG. 2 represents the control condition (i.e., the time needed for the 0 ppm surface active agent condition to reach the original interface height). The plots of FIG. 2 indicate that polyethylene glycol sorbitan monolaurate performed similarly to the foregoing surface active agent (see FIG. 1). For each of the foregoing criteria, FIG. 3 depicts the performance of polyoxyethylene sorbitan monooleate agent at concentrations of 187 ppm and 250 ppm.

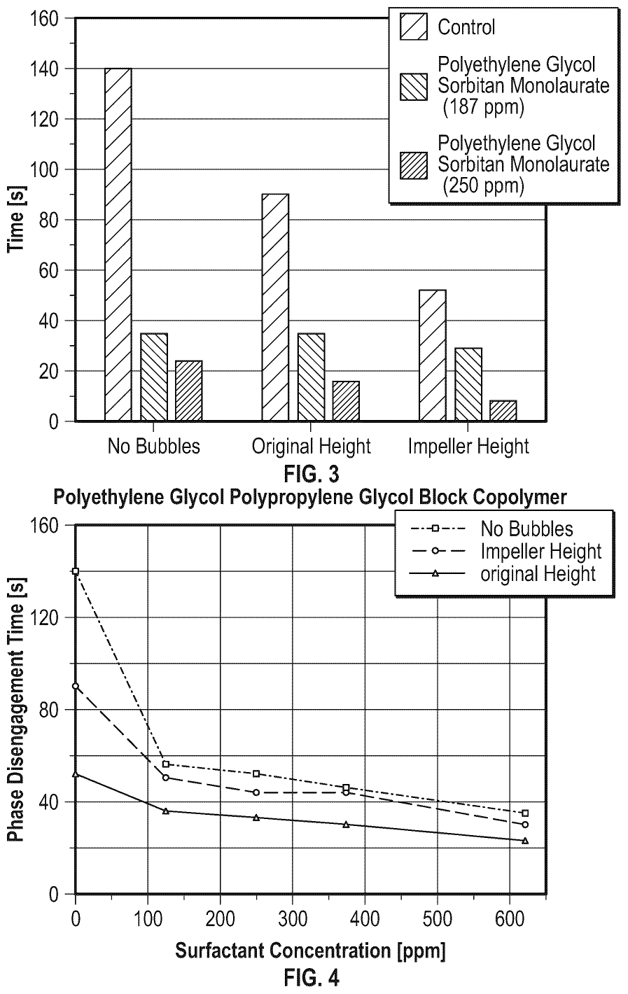

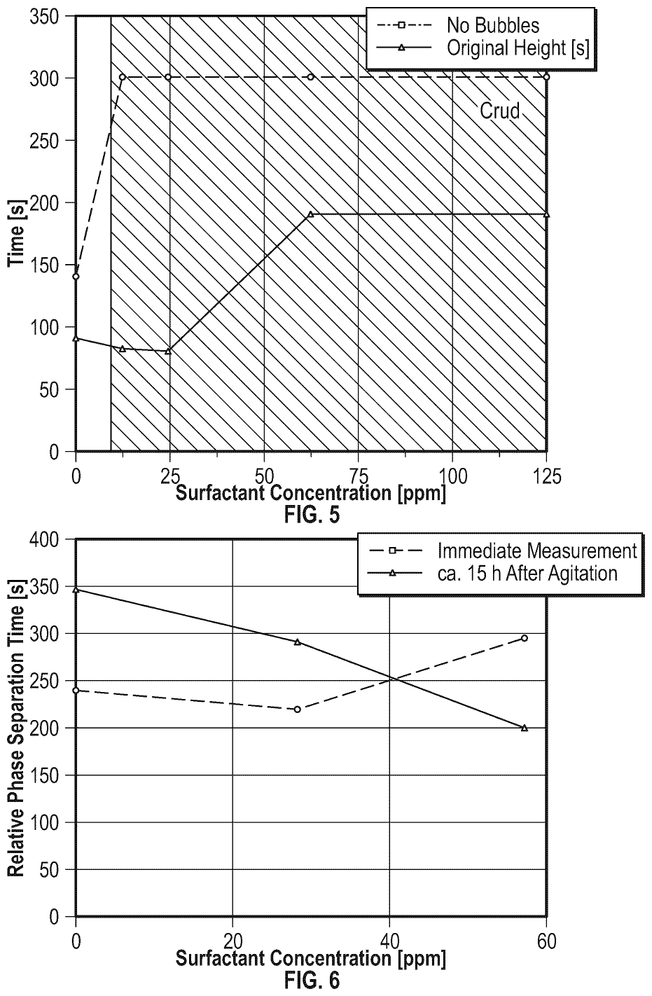

Tests also were conducted with aqueous phases containing a polyethylene glycol polypropylene glycol block copolymer at the concentrations depicted at FIG. 4. The data of FIG. 4 indicate that the polyethylene glycol polypropylene glycol block copolymer was effective in the tests at concentrations of about 100 ppm to at least about 620 ppm. It was believed that the polyethylene glycol polypropylene glycol block copolymer may facilitate operation upon varying conditions (e.g., temperature, pH, silica concentration, etc.).

Tests also were conducted with aqueous phases containing lignosulfonate at the concentrations depicted at FIG. 5. The use of lignosulfonate resulted in a very stable crud, and no aggregate silica was observed.

Tests also were conducted with sodium dodecyl sulfonate at the concentrations depicted at FIG. 6. The tests with sodium dodecyl sulfonate were initially conducted with a magnetic stirrer. The results indicated that sodium dodecyl sulfonate was not as effective as the other surface active agents tested in this example.

The results of this example indicated that the tested non-ionic surface active agents—i.e., polyethylene glycol sorbitan monolaurate, polyoxyethylene sorbitan monooleate, and a polyethylene glycol polypropylene glycol block copolymer—effectively reduced the phase disengagement time. Under the conditions used in this example, polyoxyethylene sorbitan monooleate and the polyethylene glycol polypropylene glycol block copolymer were more effective than polyethylene glycol sorbitan monolaurate at reducing phase disengagement time. The polyethylene glycol polypropylene glycol block copolymer was effective at a wider concentration range than the other surface active agents, but polyoxyethylene sorbitan monooleate generated a faster phase disengagement. These differences may not be observable under different conditions, and it should be noted that each of the tested non-ionic surface active agents were able to aggregate and sediment colloidal silica.

### Example 3—Crud Reduction

A test was conducted on an aqueous phase that included 1,000 ppm of colloidal silica, and was like that of Example 1.

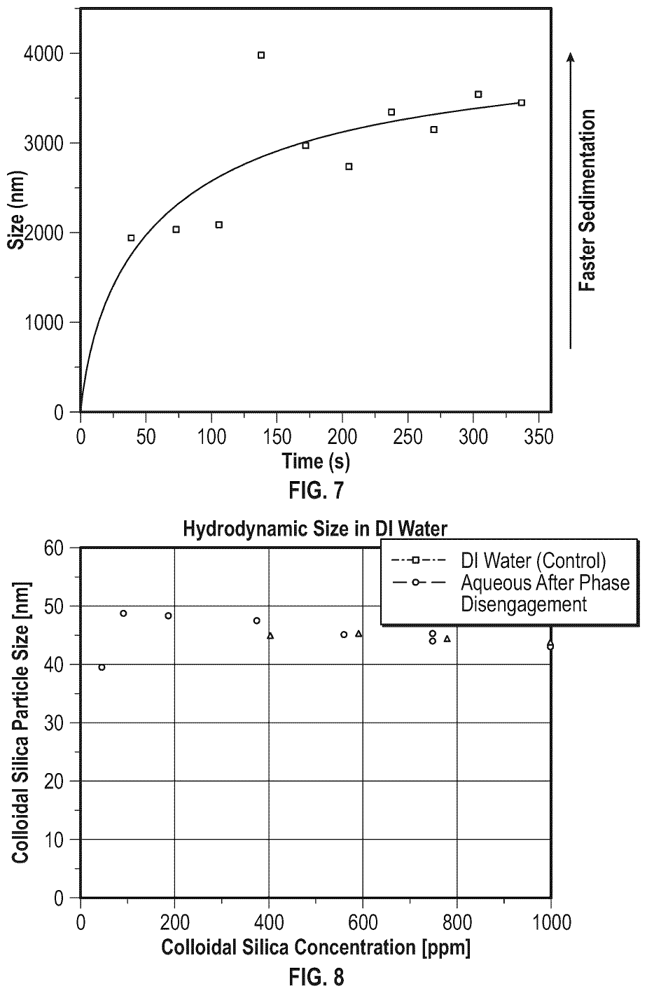

The particle size of the aqueous phase of this example was measured at various points during 350 seconds after the addition of 5 ppm the polyethylene glycol polypropylene glycol block copolymer. The results of this test were plotted, and are depicted at FIG. 7.

The particle size was measured using dynamic light scattering. At time 0 seconds, 5 ppm of a polyethylene glycol polypropylene glycol block copolymer was added to the aqueous phase, and aggregates larger than 1 μm started forming immediately. Typically, sedimentation starts as soon as aggregates reach about 1 μm.

In another test, the colloidal silica concentration was measured using dynamic light scattering. The count rate measured in kilo counts per second (kcps) was translated to colloidal silica concentration by making a calibration curve using known amounts of colloidal silica and measuring the count rate.

Silica removal efficiency was measured using a dynamic light scattering device. The following parameters were used: measurement angle of 90°, temperature of 25° C., run duration of 10 s, and one measurement was performed per sample given the good stability of the small silica particles. The attenuation was set to 11 (i.e., no attenuation).

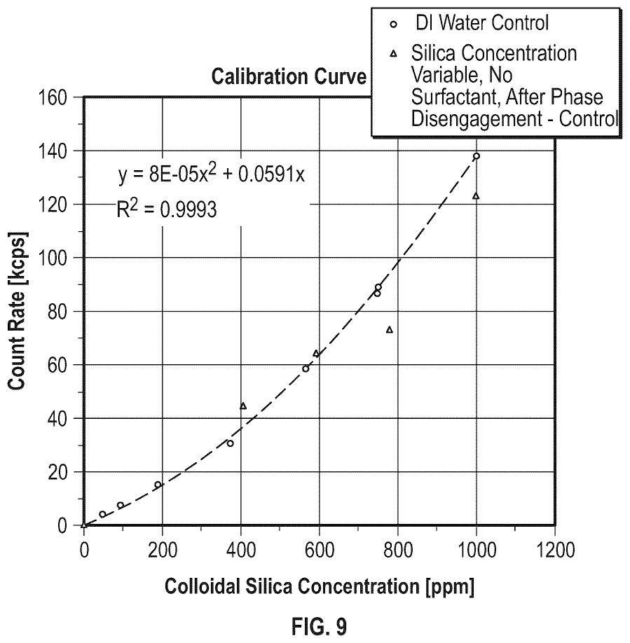

To perform the calibration curve, colloidal silica was first dispersed at varying concentrations, from 0 to 1000 ppm, in deionized water. As the mean count rate was proportional to the intensity of the scattered light, which in turn was proportional to particle size and concentration, the particle size at different concentrations was first measured in order to validate the method. FIG. 8 shows that the particle size did not change with concentration, also for standard aqueous samples after phase disengagement, indicating no aggregation at any concentration. Specifically, FIG. 8 depicts colloidal silica particle size (intensity based, zeta-average) as a function of colloidal silica concentration. Measurements were performed in deionized water (control) and after mixing and phase disengagement. All samples had a polydispersity index (PDI) around or below ca. 0.2. Then, the calibration curve was obtained by correlating the mean count rate to the known colloidal silica concentrations of the control suspensions (FIG. 9). Similar to the copper concentration calibration curve described herein, the observed trend was used to calculate the colloidal silica concentration of the suspensions after the addition of surface active agent and phase disengagement. Importantly, as it can be observed from FIG. 9, the minimum control concentration tested was 44 ppm. However, the manufacturer of the devices specified that, at best, the device may detect concentrations as low as 0.1 ppm

Various amounts of the polyethylene glycol polypropylene glycol block copolymer (5 ppm, 10 ppm, 150 ppm, 310 ppm, 625 ppm) were added to the aqueous phase after the aqueous phase was subjected to 30 seconds of centrifugation using 6700 G of centrifugal force. The detection limit of the device used in this test was 0.1 ppm, according to the manufacturer, and this limit was not sufficient to measure the residual silica in the system. Therefore, even 5 ppm of the polyethylene glycol polypropylene glycol block copolymer was sufficient to remove more than 99.99% of the silica. The same result was observed for polyoxyethylene sorbitan monooleate.

Centrifugation was used in some tests to aid silica removal from the aqueous phases, which occurred before the aqueous phases were contacted with an organic phase. When centrifugation was used in the following tests, the following parameters were applied:

| Centrifugation Time | 30 seconds or 60 seconds | |
|---|---|---|
| Centrifugal Force | ~6740 | G |
| Centrifuged Aqueous Volume | 10 | mL |

To aqueous phases containing 1,000 ppm silica, the following amounts of the polyethylene glycol polypropylene glycol block copolymer were added, and then the samples were subjected to centrifugation.

| | Polyethylene Glycol | | |
|---|---|---|---|
| | Polypropylene Glycol | | |
| Sample | Block Copolymer | | Centrifugation |
| 1 | 250 | ppm | 60 seconds at |
| 2 | 500 | ppm | 6740 G force |
| 3 | 1,000 | ppm | |
| 4 | 250 | ppm | 30 seconds at |
| 5 | 500 | ppm | 6740 G force |
| 6 | 1,000 | ppm | |

Quick sedimentation was observed for each of samples 1-6. Both centrifugation times generated robust silica pellets at all tested concentrations of the polyethylene glycol polypropylene glycol block copolymer.

A similar test was performed using relatively low surface active agent dosages. To aqueous phases containing 1,000 ppm silica, the following amounts of the polyethylene glycol polypropylene glycol block copolymer and polyoxyethylene sorbitan monooleate were added, and then the samples were subjected to centrifugation.

| | | |
|---|---|---|
| | Surface active | |
| Surface active | agent Concentration | Centrifugation |
| agent | in Aqueous Phase | Parameters |

| | | | |
|---|---|---|---|
| Polyethylene | 1 | ppm | Centrifugal |
| Glycol | 2.5 | ppm | Force - 6740 G |
| Polypropylene | 5 | ppm | Centrifugation |
| Glycol Block | 10 | ppm | Time - 30 s |
| Copolymer | | | |
| Polyoxyethylene | 1 | ppm | |
| Sorbitan | 2.5 | ppm | |
| Monooleate | 5 | ppm | |
| | 10 | ppm | |

These tests indicated that concentrations of the polyethylene glycol polypropylene glycol block copolymer and polyoxyethylene sorbitan monooleate equal to or greater than 5 ppm had substantially identical performance. The same result was observed at a larger centrifugation scale. There was no visible difference in the performance of 125 ppm, 250 ppm, and 500 ppm of the polyethylene glycol polypropylene glycol block copolymer.

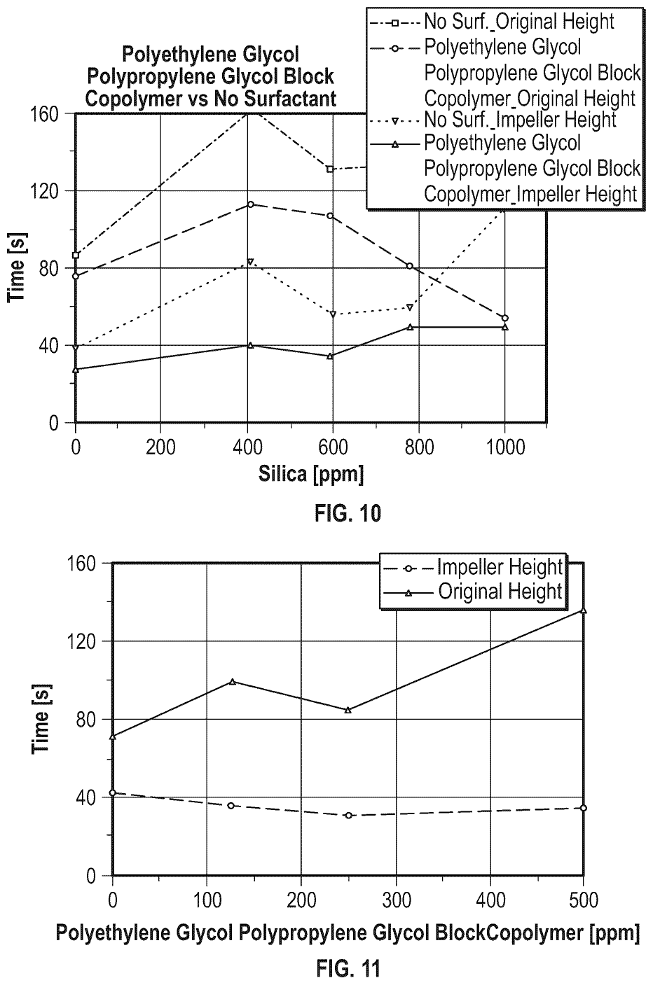

Additional testing was performed, which, as explained below, indicated that reducing or eliminating the amount of silica from the aqueous phase reduced phase disengagement times. Phase disengagement time generally increases with increasing silica content, but complete phase disengagement time was faster when a surface active agent, such as a polyethylene glycol polypropylene glycol block copolymer, was used in combination with silica concentrations greater than 400 ppm. This conclusion is demonstrated by the results of FIG. 10. Each aqueous phase tested had a concentration of a polyethylene glycol polypropylene glycol block copolymer of 250 ppm. The control sample did not include a polyethylene glycol polypropylene glycol block copolymer. At greater silica concentrations, longer phase disengagement times were observed when no additive was used, but the opposite was observed when a polyethylene glycol polypropylene glycol block copolymer was used.

A test was conducted to determine whether, after silica removal via surface active agent and centrifugation, the polyethylene glycol polypropylene glycol block copolymer could effectively reduce phase disengagement time. Based on the results depicted at FIG. 11, it was determined that the polyethylene glycol polypropylene glycol block copolymer, according to this test, did not substantially affect phase disengagement time after silica removal. The data of FIG. 11 were collected with aqueous phases originally containing 1,000 ppm silica, and subjected to the following centrifugation conditions: 7,000 G force, 30 seconds.

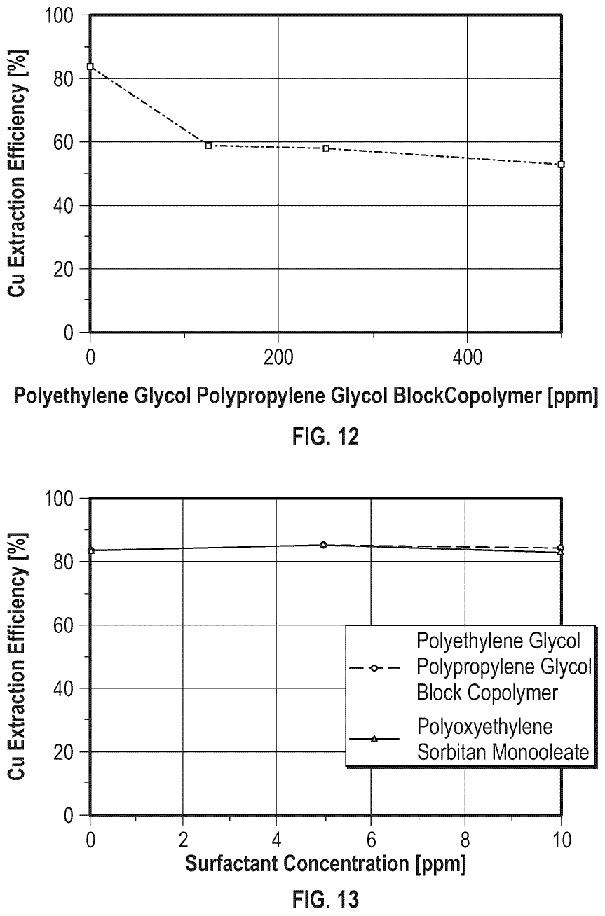

A test also was conducted to determine whether relatively high surface active agent doses may reduce copper extraction efficiency. As depicted at FIG. 12, this particular test indicated that, at least in some instances, increased surface active agent doses can lower extraction efficiency. The data of FIG. 12 were collected from aqueous phases originally containing 1,000 ppm silica, and subjected to the following centrifugation conditions: 7,000 G force for 30 seconds.

A test was conducted to determine whether silica concentration affected copper extraction efficiency. It was determined that, at least according to this test, the presence of the polyethylene glycol polypropylene glycol block copolymer and polyoxyethylene sorbitan monooleate may decrease copper extraction efficiency when used at relatively high concentrations. As depicted at FIG. 13, extraction efficiency decreased from about 85% to about 55% when 250 ppm polyethylene glycol polypropylene glycol block copolymer was used at any silica concentration up to 1,000 ppm. Polyoxyethylene sorbitan monooleate also had decreased performance.

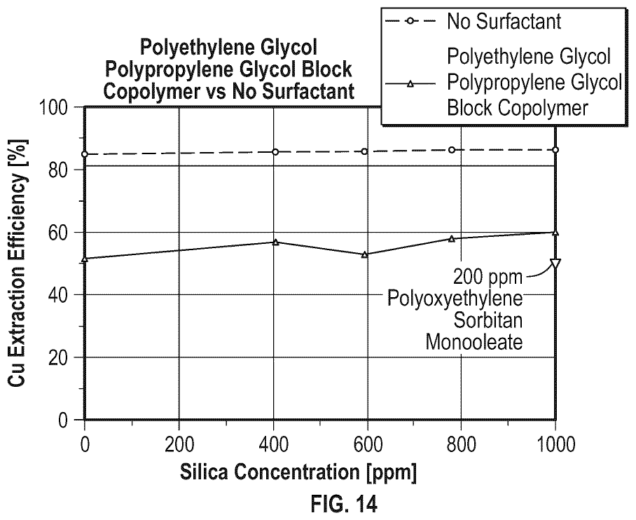

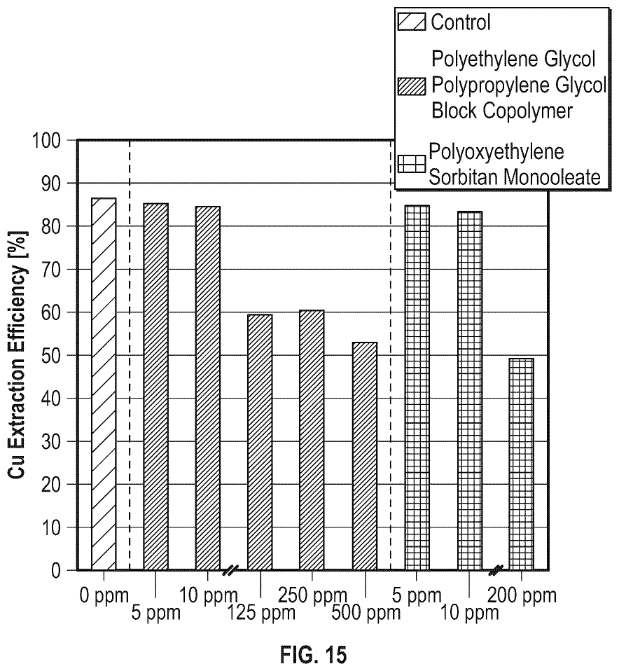

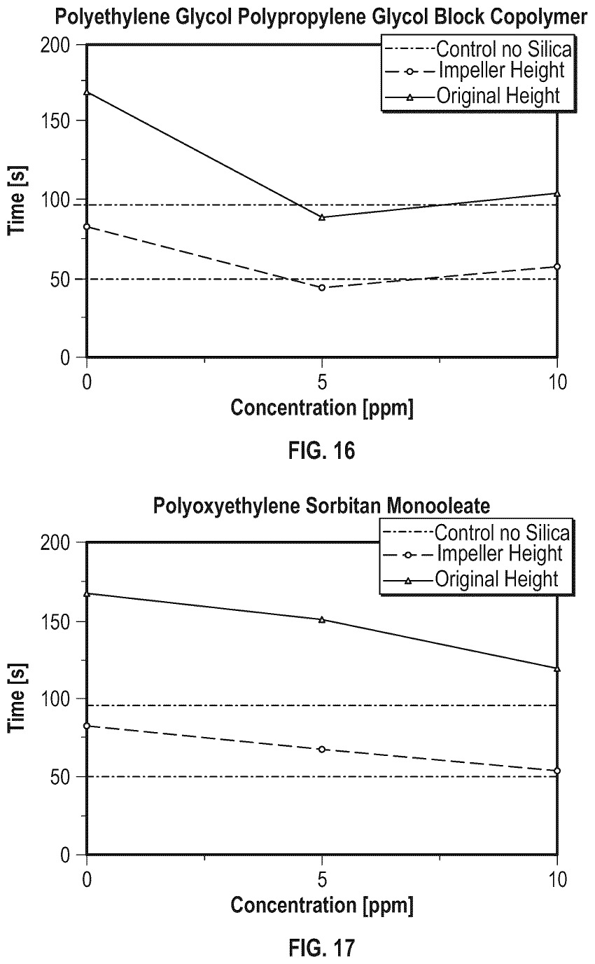

Another test was performed to determine whether copper extraction efficiency was affected by relatively low surface active agent concentration, including surface active agent concentrations effective at reducing phase disengagement time. As depicted at FIG. 14, silica was effectively removed (see above), while the same extraction efficiency was substantially maintained. FIG. 15 depicts copper extraction efficiency versus nonionic surface active agent type and concentration, as measured by UV-Vis. The effect of low additive concentration on the phase disengagement times (after centrifugation) are depicted at FIG. 16 (for the polyethylene glycol polypropylene glycol block copolymer) and FIG. 17 (for polyoxyethylene sorbitan monooleate). The initial colloidal silica concentration was 1,000 ppm, and for both surface active agents, a concentration of about 10 ppm was sufficient to reduce the phase disengagement time to levels similar to that of 0 ppm silica. These results indicated that most, if not all, silica in the systems is removed upon surface active agent addition and centrifugation.

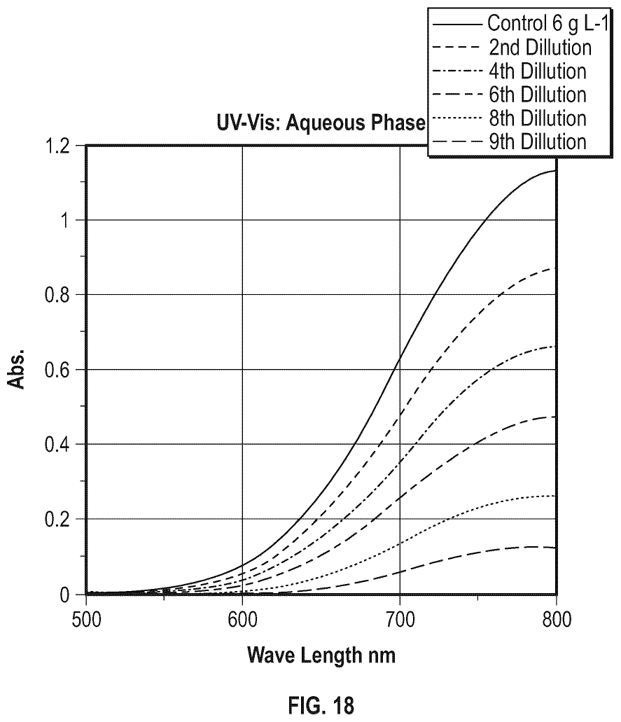

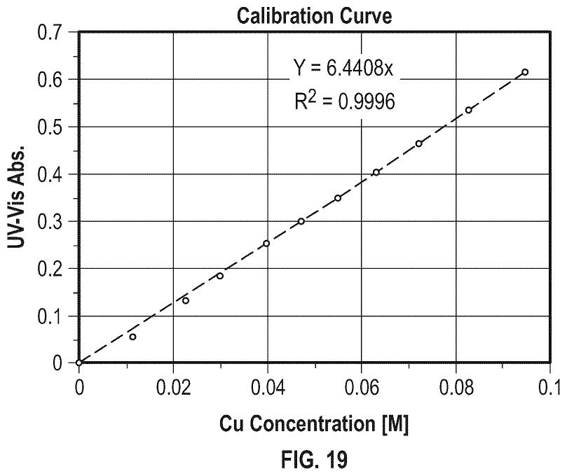

The extraction efficiency measurements were conducted as follows: a stock solution containing 6 g/L of Cu²⁺ and 3 g/L of Fe²⁺ was measured using UV-Vis. The stock was diluted and re-measured several times, as depicted at FIG. 18. In view of the known concentration after the dilution, the absorbance values at a given wavelength were used according to the Beer-Lambert Law, and this was used to estimate the concentration of the aqueous phase after phase disengagement (see FIG. 19).

1. A method of solvent extraction, the method comprising:
providing an aqueous phase comprising water and a material to be extracted;
contacting the aqueous phase and an organic phase, wherein the organic phase comprises an organic liquid and optionally an extraction reagent;
contacting the aqueous phase and a phase disengagement agent (i) before the contacting of the aqueous phase and the organic phase, or (ii) after the contacting of the aqueous phase and the organic phase; and
separating the aqueous phase and the organic phase;
wherein the separating of the aqueous phase and the organic phase is completed at a phase disengagement time that is at least 2% less than a time to separate the aqueous phase and the organic phase in the absence of the phase disengagement agent.

2. The method of claim 1, wherein the contacting of the aqueous phase and the organic phase comprises mixing the aqueous phase and organic phase for a mixing time; and
wherein the contacting of the aqueous phase and the phase disengagement agent occurs before the mixing time commences.

3. The method of claim 1, further comprising leaching the aqueous phase prior to the contacting of the aqueous phase and the organic phase, wherein the aqueous phase and the phase disengagement agent are contacted after the leaching and before the contacting of the aqueous phase and the organic phase.

4. The method of claim 1, wherein (i) the phase disengagement agent does not include a thiocarbonyl functional group, (ii) the aqueous phase does not include a compound comprising a thiocarbonyl functional group, or (iii) the phase disengagement agent does not include a thiocarbonyl functional group, and the aqueous phase does not include a compound comprising a thiocarbonyl functional group.

5. The method of claim 1, wherein the separating of the aqueous phase and the organic phase is completed at a phase disengagement time that is at least 10% less than a time to separate the aqueous phase and the organic phase in the absence of the phase disengagement agent

6. The method of claim 1, wherein the phase disengagement agent is present at an amount of about 5 ppm to about 1,000 ppm, relative to the aqueous phase.

7. The method of claim 1, wherein the phase disengagement agent comprises a surface active agent, wherein the surface active agent optionally has a weight average molecular weight of about 0.2 kDa to about 100 kDa.

8. A method of solvent extraction, the method comprising:
providing an aqueous phase comprising water, a material to be extracted, and a first amount of silica;
contacting the aqueous phase and a crud reducing agent; and
removing at least a portion of the first amount of silica from the aqueous phase to form a treated aqueous phase comprising a second amount of silica;
wherein the second amount of silica is at least 20% less than the first amount of silica.

9. The method of claim 8, further comprising:
contacting the treated aqueous phase and an organic phase, wherein the organic phase comprises an organic liquid and optionally an extraction reagent; and
separating the treated aqueous phase and the organic phase.

10. The method of claim 8, wherein (i) the crud reducing agent does not include a thiocarbonyl functional group, (ii) the aqueous phase does not include a compound comprising a thiocarbonyl functional group, or (iii) the crud reducing agent does not include a thiocarbonyl functional group, and the aqueous phase does not include a compound comprising a thiocarbonyl functional group.

11. The method of claim 8, wherein after the contacting of the aqueous phase and the crud reducing agent, the crud reducing agent is present in the aqueous phase at an amount of about 0.1 ppm to about 200 ppm.

12. The method of claim 8, wherein the removing of the at least a portion of the first amount of silica comprises centrifuging the aqueous phase, wherein the centrifuging comprises subjecting the aqueous phase to a gravitational force equivalent (g-force) up to 20,000.

13. The method of claim 8, wherein the crud reducing agent comprises a surface active agent, wherein the surface active agent optionally has a weight average molecular weight of about 0.2 kDa to about 100 kDa.

14. The method of claim 7, wherein the surface active agent is a non-ionic surface active agent, wherein the non-ionic surface active agent optionally has a hydrophilic-lipophilic balance (HLB) that is equal to or greater than 10.

15. The method of claim 14, wherein the non-ionic surface active agent is selected from the group consisting of a polysorbate, a polyoxyethylene sorbitan monooleate, a polyethylene glycol sorbitan monolaurate, and a polyethylene glycol polypropylene glycol block copolymer;
wherein, optionally, the polyethylene glycol polypropylene glycol block copolymer has a structure according to the following formula: 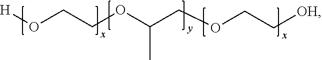
wherein x is 2 to 150, and y is 5 to 100.

16. The method of claim 15, wherein the non-ionic surface active agent comprises the polyethylene glycol polypropylene glycol block copolymer, and the polyethylene glycol polypropylene glycol block copolymer has the structure according to the following formula: 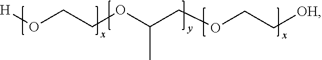
wherein x is 2 to 150, and y is 5 to 100.

17. The method of claim 1, wherein the organic phase comprises the extraction agent.

18. The method of claim 14, wherein the non-ionic surface active agent has a hydrophilic-lipophilic balance (HLB) that is equal to or greater than 10.

19. The method of claim 13, wherein the surface active agent is a non-ionic surface active agent.

20. The method of claim 19, wherein the non-ionic surface active agent has a hydrophilic-lipophilic balance (HLB) that is equal to or greater than 10.
